(19) United States
(12) Patent Application Publication
(10) Pub. No.: US 2012/0025514 A1
(43) Pub. Date: Feb. 2, 2012

(54) SECURITY ELEMENT INCLUDING TWO STACKED DISTINCT PATTERNS, SECURITY DOCUMENT CONTAINING SAME, AND RELATED METHODS

(75) Inventor: Michel Camus, Rives Sur Fure (FR)

(73) Assignee: ARJOWIGGINS SECURITY, Paris, FR (FR)

(21) Appl. No.: 13/147,549

(22) PCT Filed: Feb. 3, 2010
(86) PCT No.: PCT/IB10/50503

§ 371 Date: Oct. 17, 2011

(30) Foreign Application Priority Data
Feb. 3, 2009 (FR) 09 50668

(51) Int. Cl. B42D 15/00

(52) U.S. Cl. 283/67; 283/72

(57) ABSTRACT

The invention relates to a security element (1) that comprises an at least partially transparent substrate, on the front and back of which are formed first (3) and second (4) markings in the form of metallisations and/or printings, respectively, the first markings (3) being mostly stacked on the second markings (4), the first and second markings (3, 4) defining first and second patterns, respectively, which have separate respective surfaces, wherein the visibility level of the second markings (4) varies together with the observation angle of the front of the security element (1), and the thickness of the substrate is 5 to 100 μm.

The present invention pertains to the field of security documents.

It relates to a security element, a security document comprising same and the associated methods of authentication and manufacture.

### BACKGROUND

To guard against counterfeits or falsifications of security documents and so as to increase the level of security of these documents, it is known to incorporate therein one or more security elements. The security element or elements are preferably chosen so as to be easily recognizable by the man in the street and in such a way that they are also difficult to counterfeit with the technologies available on the market.

The use of security elements relying on the principle of a hidden image which becomes visible under certain observation conditions and thus allows authentication of the security element, has already been envisaged in the prior art. Security documents enabling a “moiré pattern effect” to be obtained in see-through manner are known for example from documents GB 173 767 and EP 0 279 526. It is possible for example, through a moiré pattern effect, for a pattern to be made to appear, produced by superimposing two security elements, for example by bringing closely together lines of two security elements, the latter possibly corresponding to prints produced respectively on the recto and the verso of the security document.

Security documents comprising on one of their faces rastered patterns printed with preferential raster orientations or different print heights, and intended to be observed from a given observation angle so as to allow their authentication, are likewise known from documents U.S. Pat. No. 4,033,059, EP 0 146 151 and FR 2 231 451.

Security documents comprising dissociated and shifted images, one part of an image being for example printed on the recto of the document and the other part of the image being printed on the verso of the document, are also known from documents WO 95/09731 and EP 1 886 827. The hidden image then appears by observation of the security document in see-through manner or by observation from a given angle.

Also known are security elements comprising an image that is hidden, for example within a print or a hologram, requiring the use of an exterior filter in order to be visible, or else the use of dissociated print elements on a security document requiring the reassociation of the elements by folding the document so as to make it possible to see a hidden image.

Application WO 2006/066803 describes a thick plastic card on the recto and the verso of which are partially and respectively contained first metallizations and second metallizations whose visibility varies as a function of the angle of observation of the recto or of the verso of the card.

Application WO 2005/100040 describes a security document comprising a metallic image on its recto and a hologram on its verso.

Application US 2004/233463 describes a method for printing color images using transparent inks and metallic inks.

The solutions proposed by the prior art exhibit several drawbacks however. For example, the printing methods used do not make it possible to obtain the necessary precision to form dissociated parts of an image on either side of a security document. Moreover, the technologies used are difficult to implement during the manufacture of the security document since they may require the creation of specific elements on the document, for example observation windows or particular translucent zones, or may require the use of a separate external filter. Furthermore, the technologies of the prior art are not suited to a security element exhibiting reduced dimensions, in particular a security thread, which exhibits several constraints.

### SUMMARY

Consequently there exists a requirement to remedy at least some of the drawbacks mentioned hereinabove.

There exists in particular a requirement to further enhance the security and the processes for authentication of security documents, so as in particular to increase the difficulty of counterfeiting these documents.

There also exists a requirement to provide a novel method for manufacturing a security element using the principle of a hidden image visible under certain observation conditions, which is moreover suited to a security element in the form of a security thread.

The invention is aimed at addressing all or some of these requirements.

The subject of the invention is thus, according to one of its aspects, a security element comprising an at least partially transparent substrate, on the recto and the verso of which are contained respectively and partially first marks and second marks in the form of metallizations and/or of prints, the first marks being superimposed mainly on the second marks (or vice versa), the first marks and second marks forming respectively first and second distinct patterns on their respective faces, the degree of visibility of the second marks varying with the angle of observation of the recto of the security element.

The expression “being superimposed mainly” is understood to mean that the first marks overlap the major part, in particular at least 50%, better 80%, better 90%, better 95%, better 100%, of the surface of the second marks or vice versa.

The widths of the first marks may be 2 times greater than the widths of the second marks, better 1.5 times, better 1.2 times, better equal, or vice versa. The mutual overlap, preferably total, of the marks may be observed at a predefined angle of observation of the security element, in particular along the normal to the recto or to the verso of the security element.

The first marks may be superimposed substantially totally on the second marks or vice versa.

The first marks may in particular be superimposed exactly, that is to say totally, on the second marks or vice versa. Thus, when one of the faces of the security element, recto or verso, is observed along the normal to this face (observation from the vertical), only the marks present on this face can visible, the latter marks then masking the marks of the other face. In particular, when the recto of the security element is observed from the vertical, only the first marks forming the first pattern are visible (the second marks forming the second pattern then being hidden). Conversely, when the verso of the security element is observed from the vertical, only the second marks forming the second pattern are visible (the first marks forming the first pattern then being hidden). Stated otherwise, the first marks and second marks are made exactly in register with respect to one another, according to predefined positions.

The marks situated on the side of the face of the security element that is observed by the user may be wider, in particular have a larger area, than the marks situated on the face opposite from the observed face. The widths of the first marks can thus be greater than or equal to the widths of the second marks.

When one of the faces of the security element is observed at a nonzero angle with respect to the normal to this face (observation at an inclined angle), it is possible to observe an image resulting from the superposition of the first and second patterns. In particular, observing the recto of the security element at an inclined angle can make it possible to see the second marks forming the second pattern. Observing the verso of the security element at an inclined angle can make it possible to see the first marks forming the first pattern. The superposition of the first marks and of the second marks with respect to one another (in particular according to an exact registration) must in particular be carried out as perfectly as possible so as to prevent the observation of the image resulting from the superposition of the first and second patterns when observing from the vertical, and to allow visibility of the image when observing at an inclined angle.

In particular, the degree of visibility of the second marks (or of the first marks) can change as a function of the direction of observation of the recto (or verso) face of the security element. For example, when the angle of observation increases with respect to the normal to the recto (or to the verso) of the security element, the degree of visibility of the second marks (or of the first marks) can increase accordingly.

The second marks may be visible only by observing the security element from an angle different from 90° with respect to the observed face of the security element. In this way, it is possible to guard against attempted counterfeiting, in particular by photocopying.

All or part of a first part of the second marks may be visible only by observing from a first angle and all or part of a second part of the second marks may be visible only by observing from a second angle different from the first angle.

All or part of the first part of the second marks may also be visible by observing from the second angle.

The first marks and second marks may advantageously be situated on either side of a transparent zone of the substrate. Preferably, the substrate may be totally transparent.

The substrate may be visible between the first marks and second marks. In particular, the parts of the recto and of the verso of the substrate that are not overlapped by the first marks and the second marks may be overlapped either by no element, or by a transparent element, for example a transparent varnish or a heat-sealing varnish.

The first marks and/or second marks may be prints and/or metallizations. For example, the first marks and/or second marks can correspond to an alternation of prints and metallizations.

The first marks may be prints and the second marks may be metallizations, or vice versa.

The first marks and/or second marks may be prints, for example in the form of prints chosen from among: ink jet prints, offset, laser, copper-plate, heliogravure, silk-screen printing, flexography, or known printing technologies making it possible in particular to attain the required printing fineness.

The first marks and/or second marks can furthermore be metallizations carried out for example by application of one or more metallic layers, and to undertake the demetallization by the appropriate technologies: application of a varnish resistant to chemical attacks (commonly called “resist”) and then attack by a soda solution, sublimation of the metal by use of a laser or other known technologies.

The metallizations may comprise aluminum, copper, gold, nickel, silver or other metal that can be deposited by vacuum evaporation or by chemical deposition. Reference may more particularly be made to application FR 1 577 660 as regards the reduction of a metallic salt solution.

The first marks and second marks may be of the same nature and produced in a similar manner. In particular, the first marks and second marks may all be prints (or metallizations) of the same type, produced by the same method.

The first marks and second marks may have the same width and/or the same length.

The first marks and/or second marks may or may not be opaque. In particular, they can at least partially diffuse the light passing through them.

The first marks and/or second marks may comprise pigments that are goniochromatic, iridescent, luminescent, fluorescent, phosphorescent, photochromic, thermochromic, piezochromic, transparentizing, inter alia.

The aspect of the first marks and/or second marks, in particular the color, can vary as a function of the angle of observation. For example, the aspect of the first marks can vary for a predefined angle of observation indicating at the same time that the second marks must be visible for this predefined angle.

Observation of the security element can also be combined with another security element, present for example elsewhere on a security document comprising the security element according to the invention, this other security element being visible only for the angle of observation making it possible to see the image formed by the combination of the first and second patterns of the first marks and second marks.

Observation of the security element may or may not be done with the naked eye, under visible, ultraviolet (UV) or infrared (IR) light.

All or only some of the first marks and/or of the second marks can comprise at least two different nature zones, in particular of different colors, making it possible to observe different effects on the image formed by the combination of the first and second patterns. For example, the second marks can comprise in their left part a zone of a first color and in their right part a zone of a second color, different from the first color. When observing the recto of the security element from the left or the right of the security element, it may thus be possible to observe a combined image of the first and second patterns having a different color, in particular the first or the second color.

At least one of the patterns can be totally superimposed on the other of the patterns. In this way, it may thus be possible to facilitate the complete visualization of the image resulting from the combining of the first and second patterns.

The first marks and/or the second marks may comprise a pattern in the form of a rastered image. It is necessary for the expression “rastered image” to be given a broad sense which covers all types of rasters or pseudo-rasters, comprising a juxtaposition of bright zones and of dark zones, distinguishable from one another, the shape of these bright zones and of these dark zones not being limited to a particular shape but being able to be arbitrary.

The rastered image may for example comprise a set of dots and/or of lines that may or may not be mutually parallel, whose size and/or mutual spacing are variable or constant, this set forming for example a juxtaposition of bright and dark zones, for example white and black. The raster dots may thus for example be dashes.

The rastered image may in particular comprise a set of lines, preferably mutually parallel, of defined widths and mutual spacings. In particular, the lines may have the same width and/or the same mutual spacing. Each line can correspond to a mark. All or part of the lines may have a variable width.

The rastered image may for example comprise a juxtaposition of dark and bright lines, for example black and white.

As a variant, the rastered image may comprise a set of elements of variable shape constituting the raster of the image, these elements being equidistant or not from one another. These elements can for example be dots, of for example circular, oval, star-shaped, polygonal, for example square, rectangular, triangular, inter alia.

The first and second patterns may be formed by parallel lines with the same line count.

The first and second patterns may be distinct through their shape, through their size, through their number, in particular the repetition of several similar sub-patterns, inter alia.

The security element may be a security thread. The security element may furthermore be a patch or a foil.

The width of the security element may lie between 1 and 30 mm preferably between 4 to 15 mm.

The thickness of the substrate may lie between 5 and 100 μm, preferably between 10 and 100 μm, better between 10 and 50 μm, better between 15 and 35 μm, preferably still between 15 and 30 μm.

The thickness of the substrate may be strictly less than 100 μm, preferably less than 50 μm, better less than 35 μm and preferably still less than 30 μm. The low thickness of the substrate can make it possible to easily incorporate the security element into a security document, in particular such as described hereinafter.

Furthermore, the low thickness of the substrate can make it possible to produce first marks and/or second marks of reduced dimensions, in particular in the form of micro-patterns produced in the form of metallizations and/or of prints. It is thus possible to produce the first marks and/or second marks for example in the form of a fine rastered image, which is difficult to counterfeit.

The substrate can comprise a polymer chosen from among polyethylene (PE), polyvinyl chloride (PVC), polyethylene terephthalate (PET), polycarbonate (PC), polyester carbonate (PEC), polyethylene terephthalate glycol (PETG), acrylonitrile butadiene styrene (ABS).

The substrate can comprise a light-collecting film of the “waveguide” type. By way of example, such films are marketed by the company BAYER under the brand LISA®.

The substrate can comprise microreliefs on at least one of its faces. The microreliefs can for example make it possible to create diffracting visual effects.

The security element can comprise a so-called positive resin layer, capable of being modified chemically under the action of ultraviolet radiation (UV) and of becoming soluble in an appropriate solvent, this resin layer being disposed on at least one of the recto and of the verso of the substrate.

The resin layer may be disposed between the substrate and the first marks and/or between the substrate and the second marks.

The security element can also comprise at least one non-opaque colored layer, in particular a transparent colored layer, this colored layer being applied to at least one of the recto and of the verso of the substrate.

The colored layer may for example comprise pigments chosen from among pigments that are iridescent, luminescent, fluorescent, phosphorescent, photochromic or thermochromic.

The colored layer may be situated between the substrate and the first marks and/or between the substrate and the second marks.

The colored layer can as a variant be situated on the external face of the first marks and/or on the external face of the second marks.

The presence of one or more colored layers can thus make it possible to achieve particular visual effects when observing the image resulting from the combining of the first and second patterns. In particular, at least one of the first and second patterns can appear colored during observation.

The subject of the invention is furthermore, according to another of its aspects, a security document comprising a security element such as defined above.

The security element may be a security thread introduced in bulk or as window(s) into the security document, or can furthermore be applied at the surface on the security document.

The security document can in particular be chosen from among a means of payment, such as a banknote, a check or a restaurant voucher, an identity document, such as an identity card or a visa or a passport or a driver's license, a lottery ticket, a transport pass or else an entry ticket to cultural or sports events.

The security document can furthermore be an article chosen from among a security label, packaging, especially packaging for medicines or for foods or for cosmetics or perfumes or for electronic parts or for spare parts.

The subject of the invention is furthermore, according to another of its aspects, a method of authentication of a security element or of a security document such as defined above, in which:
the recto and/or the verso of the security element is/are observed at a nonzero angle of observation with respect to the normal to the recto and/or to the verso of the security element (observation from the vertical),
authentication of the security element or of the security document is confirmed with the appearance of the image formed by the second pattern.

The angle of observation of the complete hidden image can lie between 20° to 70° and preferably be equal to 45°. The person skilled in the art will indeed be able to determine said angle in particular as a function of the thickness of the substrate of said security element, of the thickness of the prints and/or metallizations of said security element and of the dimensions of said first marks and second marks.

Observation can be done at the level of the transparent zones of the substrate that are not overlapped by the first marks and the second marks. In particular, observation of the recto of the substrate can make it possible to see the second pattern formed by the second marks. Observation of the verso of the substrate can make it possible to see the first pattern formed by the first marks.

The subject of the invention is furthermore, according to another of its aspects, a method for manufacturing a security element such as defined above, in which first marks and second marks in the form of metallizations and/or of prints are formed partially on the recto and the verso of an at least partially transparent substrate, in such a way that the first marks are for the main part superimposed on the second marks and that the first marks and second marks form respectively first and second distinct patterns according to their respective faces.

The method can furthermore comprise the steps in which:
a first demetallization of a metallic layer present on the recto of the substrate is performed so as to form the first marks,
a replica of the first marks is formed on the verso of the substrate,
another demetallization of the first marks and/or second marks is performed so as to form the first and second distinct patterns.

The first demetallization of the metallic layer present on the recto of the substrate can be done by an optical process by illuminating the recto of the substrate.

The optical process can correspond to illumination by a laser which can make it possible to form the first marks and the second marks simultaneously by sublimation of the metallized parts. In particular, the first marks and second marks can thus be formed exactly in register with one another. They may be exactly superimposed on one another. In the case of the use of laser technology, reference may be made to patent WO 2002/101147.

Said other demetallization of the first marks and/or second marks making it possible to form the first and second distinct patterns may be performed by placing a mask (or screen) on the first marks and/or the second marks so as to mask them at least partially, and then by subjecting the marks not masked by the mask to a chemical treatment, in particular of the soda type, so as to form the first and/or second patterns.

The first demetallization of the metallic layer present on the recto of the substrate can furthermore be done by an optical process by illuminating the recto of the substrate and/or by chemical treatment. The chemical treatment can correspond to a chemical attack of unmasked parts of the first marks.

The replica of the first marks on the verso of the substrate can in particular be done by an optical process by illuminating the recto of the substrate. The process can correspond to an ultraviolet illumination (UV) of the recto face of the substrate allowing irradiation of a resin layer, in particular a so-called positive resin capable of being modified chemically under the action of UV radiation, and situated between the verso of the substrate and a metallic layer so as to form the second marks.

The subject of the invention is furthermore, according to another of its aspects, a security element comprising an at least partially transparent substrate, on the recto and the verso of which are contained respectively and partially first marks and second marks in the form of metallizations and/or of prints, the first marks being superimposed mainly on the second marks, the first marks and second marks forming respectively first and second distinct patterns according to their respective faces, the degree of visibility of the second marks varying with the angle of observation of the recto of the security element, the first marks and/or the second marks comprising a pattern in the form of a rastered image comprising a set of mutually parallel lines.

The subject of the invention is furthermore, according to another of its aspects, a security element comprising an at least partially transparent substrate, on the recto and the verso of which are contained respectively and partially first marks and second marks in the form of metallizations and/or of prints, the first marks being superimposed mainly on the second marks, the first marks and second marks forming respectively first and second distinct patterns according to their respective faces, the degree of visibility of the second marks varying with the angle of observation of the recto of the security element, the first and second patterns being formed by parallel lines with the same line count.

The subject of the invention is furthermore, according to another of its aspects, a security element comprising an at least partially transparent substrate, on the recto and the verso of which are contained respectively and partially first marks and second marks in the form of prints, the first marks being superimposed mainly on the second marks, the first marks and second marks forming respectively first and second distinct patterns according to their respective faces, the degree of visibility of the second marks varying with the angle of observation of the recto of the security element.

The subject of the invention is furthermore, according to another of its aspects, a security element comprising an at least partially transparent substrate, on the recto and the verso of which are contained respectively and partially first marks and second marks in the form of metallizations and/or of prints, the first marks being superimposed mainly on the second marks, the first marks and second marks forming respectively first and second distinct patterns according to their respective faces, the degree of visibility of the second marks varying with the angle of observation of the recto of the security element, the second marks and/or the first marks being formed by at least two sets consisting of different prints, in particular of different colors, and/or of different metallizations.

Said at least two sets forming the second marks and/or the first marks may be juxtaposed or spaced mutually apart. Said at least two sets can furthermore be in part juxtaposed and in part spaced mutually apart.

Said at least two sets may be of different width and/or of different height.

A first set consisting of first prints and/or metallizations can for example be visible only when observing the recto of the security element from just one side of a plane of separation making a nonzero angle with the recto of the security element, and a second set consisting of second prints and/or metallizations can for example be visible only when observing the recto of the security element from the other side of the plane of separation. The plane of separation can correspond to the mid-plane of the recto of the security element.

The invention may be better understood on reading the detailed description of nonlimiting examples of implementation of the latter, and on examining the schematic and partial figures of the appended drawing in which:

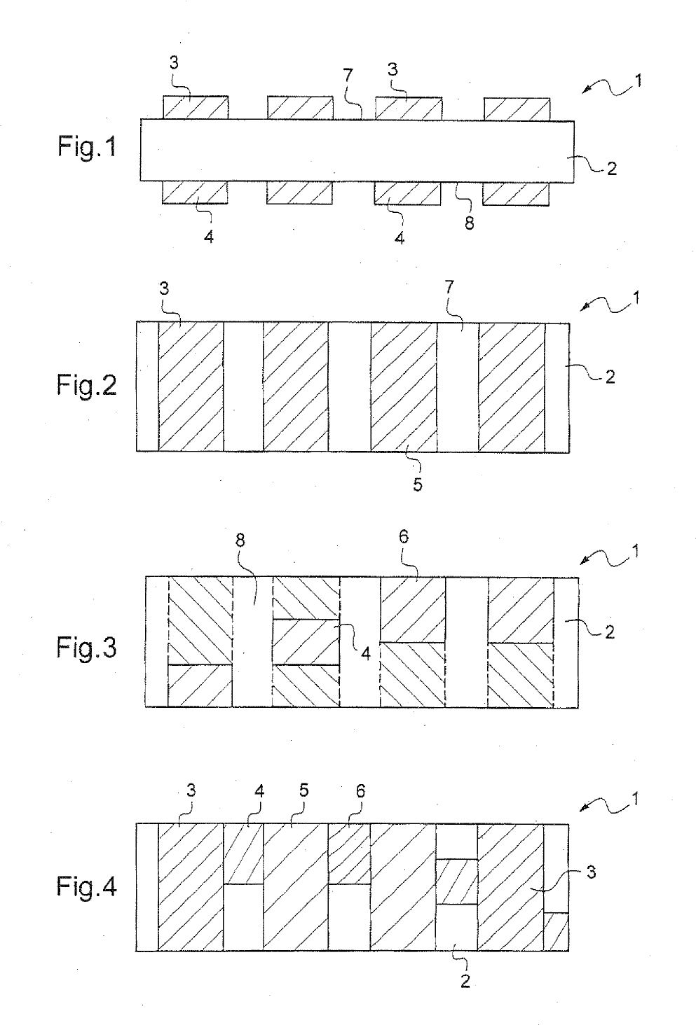

FIG. 1 represents, in section, an example of a security element according to the invention,

FIG. 2 represents, in a face-on view, the recto of the security element of FIG. 1,

FIG. 3 represents, in a face-on view, the verso of the security element of FIG. 1,

FIG. 4 represents, in a face-on view, the image resulting from the combining of the first and second patterns of the security element of FIG. 1 under observation at an inclined angle,

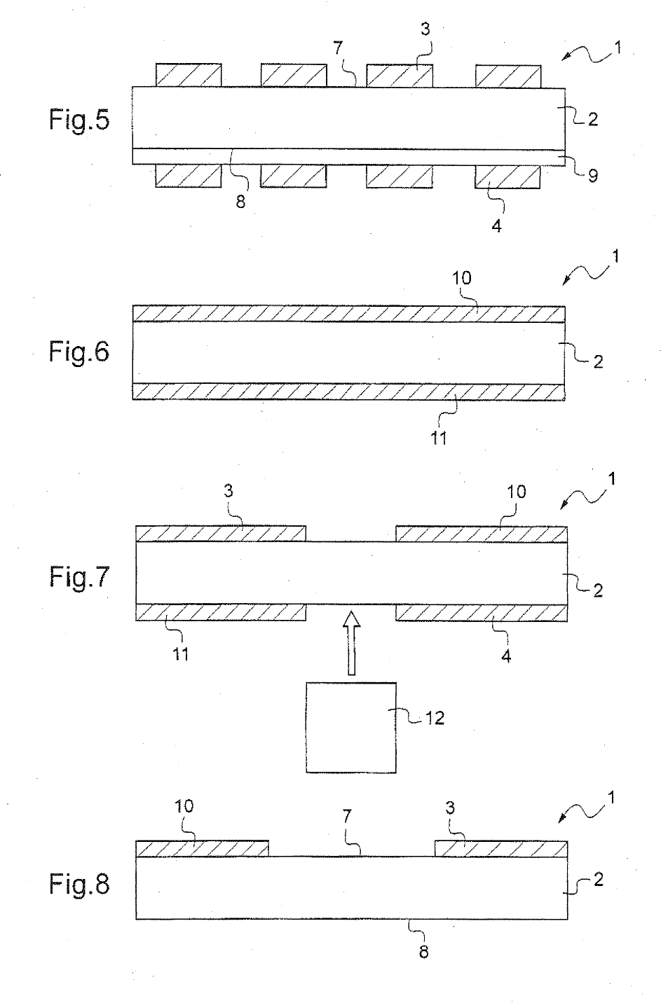

FIG. 5 represents, in section, a variant embodiment of a security element according to the invention,

FIGS. 6 and 7 represent, in section, steps of the method for manufacturing a security element according to the invention,

FIGS. 8 to 11 represent, in section, other steps of a method for manufacturing a security element according to the invention,

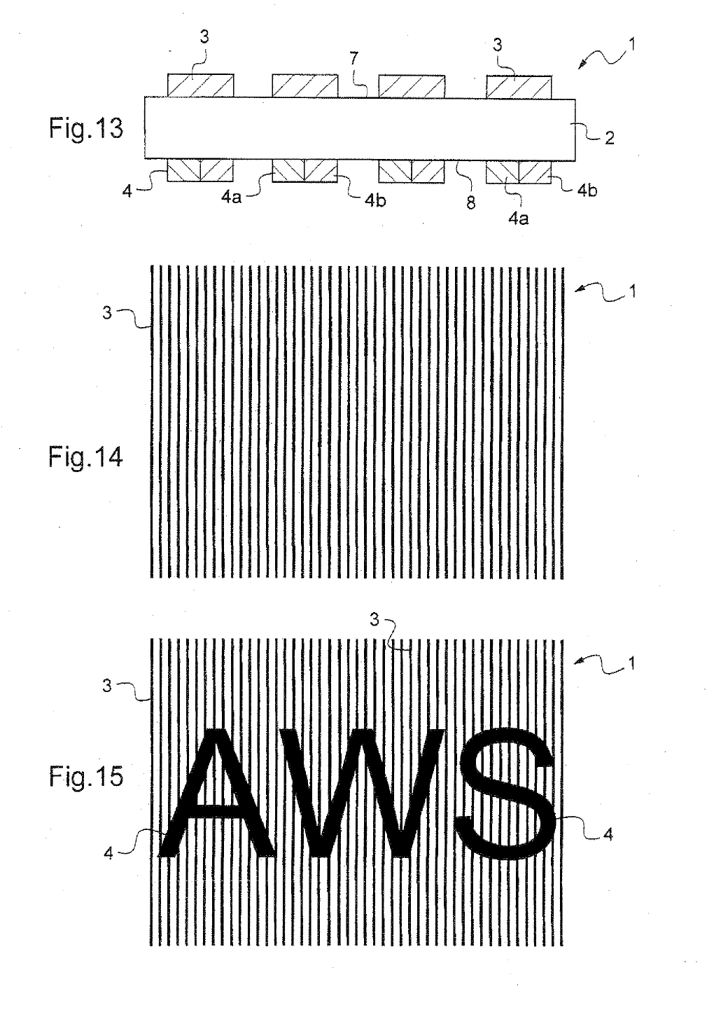

FIGS. 12 and 13 represent, in section, other variant embodiments of security elements according to the invention,

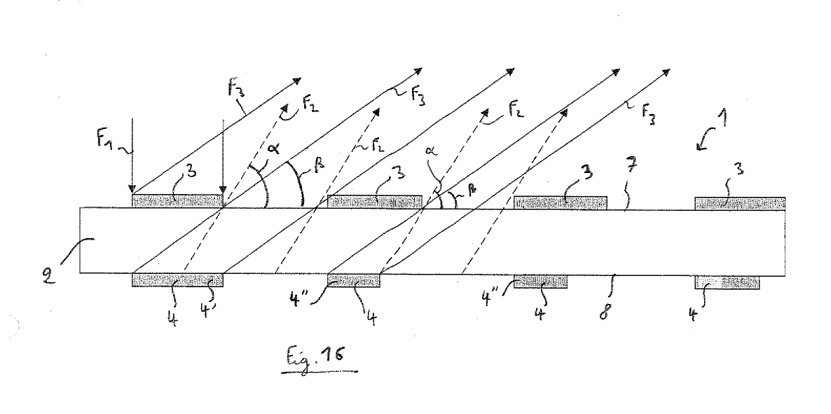

FIGS. 14 and 15 represent, in a face-on view, two examples of photographs of the observation of a security element in accordance with the invention, and

FIG. 16 represents, in section, another exemplary security element according to the invention comprising first marks and second marks respectively visible according to a different first and second angle.

In the figures, the dimensions and the proportions have not always been adhered to for the sake of clarity and understanding.

An exemplary security element 1 in accordance with the invention has been represented, in section, in FIG. 1.

The security element 1 comprises an at least partially transparent, preferably totally transparent, substrate 2 on the recto 7 and the verso 8 of which are contained respectively first marks 3 and second marks 4.

The marks 3 and 4 are distributed over the recto 7 and the verso 8 of the substrate 2 in a partial manner.

The marks 3 and 4 may be in the form of metallizations and/or of prints, produced in a manner such as described above.

The first marks 3 and the second marks 4 are respectively disposed on the recto 7 and the verso 8 of the substrate 2 in such a way that they are totally superimposed on one another. In this way, when the security element 1 is observed from the vertical, that is to say at a nonzero angle of observation with respect to the normal to the recto 7 or to the verso 8 of the security element 1, it is possible to observe only the first marks 3 when observing the recto 7 or only the second marks 4 when observing the verso 8.

The first marks 3 form a first pattern 5 distinct from a second pattern 6 formed by the second marks 4. The first and second patterns 5 and 6 can be differentiated in one of the ways described above.

The recto 7 of the security element 1 has been represented in FIG. 2, in a face-on view. FIG. 2 represents the observation of the recto 7 according to a vertical observation, in such a way that only the first marks 3 can be seen.

The first marks 3 form a first pattern 5 in the form of a rastered image comprising parallel lines of equal and equidistant thicknesses.

The verso 8 of the security element 1 has been represented in FIG. 3, in a face-on view.

FIG. 3 represents observation vertically in line with the verso 8, in such a way that it is possible to see the second marks 4, as well as, through said substrate of said security element, the first marks 3.

The second marks 4, form a second pattern 6 which corresponds to a rastered image comprising blocks of variable sizes distributed differently on the verso 8 of the substrate 2.

Represented in FIG. 4 is the aspect of the security element 1 when observed at an inclined angle making it possible to see the image resulting from the combination of the patterns 5 and 6. In this example in particular, the observation is performed at an angle inclined by 45 degrees with respect to the normal to the recto 7 of the substrate 2, the angle being measured clockwise. As a variant, the observation could be performed from a different angle, in particular greater than or equal to 45 degrees, measured for example anticlockwise. The observation could also be performed from the side of the verso 8 of the substrate 2.

Observation at an inclined angle can also make it possible to see the image resulting from the superposition of the patterns 5 and 6. In particular, the second marks 4 may be visible through the transparent spaces of the substrate 2 between the first marks 3.

In this way, it is possible to authenticate the security element 1.

The security element 1 can comprise any one of the characteristics described above. In particular, the substrate 2 can correspond to a transparent polyester layer having a thickness equal to 20 μm. The first marks and second marks 3 and 4 can correspond to aluminum metallizations.

A variant embodiment of the security element 1 of FIG. 1 has been represented, in section, in FIG. 5.

In this variant, the security element 1 comprises a transparent colored layer 9 disposed on the recto 8 of the substrate 2, between the substrate 2 and the second marks 4.

In this way, when observing the security element 1 at an inclined angle, the first marks 3 and/or the second marks 4 can appear colored. In particular, under observation at an inclined angle of the recto 7 of the security element 1, the second marks 4 can appear colored on account of the presence of the second colored layer 9. When observing the verso 8 of the security element 1, the first marks 3 can appear colored on account of the presence of the colored layer 9.

As a variant, the colored layer 9 could be disposed on the recto 7 of the substrate 2. The colored layer 9 could also be disposed partially on the recto and/or the verso of the substrate 2, in particular without extending from one edge to the other of the substrate 2. The colored layer 9 could furthermore be disposed on the external faces of the first marks 3 and/or of the second marks 4. The security element 1 could in particular comprise several colored layers 9.

Two steps of a method for manufacturing a security element 1 in accordance with the invention have been represented in FIGS. 6 and 7.

In a first step represented in FIG. 6, an at least partially transparent substrate 2 is covered on either side of its faces by a first 10 and a second 11 metallic layer, for example of aluminum. The first and second metallic layers 10 and 11 are respectively intended to form the first marks 3 and the second marks 4.

The step consisting in performing a demetallization of the metallic layers 10 and 11 so as to form the marks 3 and 4 has been represented in FIG. 7.

The demetallization is obtained with the aid of a laser 12 directed onto the recto or the verso of the security element 1. The laser 12 makes it possible to remove at one and the same time the metallic parts of the metallic layer 11 that it crosses and also the metallic parts of the metallic layer 10 which are exactly superimposed on the removed parts of the metallic layer 11. The result obtained makes it possible to have first marks 3 and second marks 4 which are placed on the substrate 2 exactly in register, totally superimposed on one another.

The method can furthermore comprise a step consisting in placing a screen on at least one of the faces of the security element 1 so as to partially mask the first marks and/or second marks 3 and 4, and then in subjecting the first marks and/or the second marks 3 and 4 not masked by the screen to a chemical treatment, in particular of the soda type, so that they are made to disappear. In this way, it is possible to form the first 5 and/or the second 6 corresponding pattern.

Steps of another method for manufacturing a security element in accordance with the invention have been represented, in section, in FIGS. 8 to 11.

In the step represented in FIG. 8, an at least partially transparent substrate 2 is covered on its recto 7 by a first metallic layer 10 which is demetallized so as to form the first marks 3.

The demetallization may be obtained with the aid of a laser or else with the aid of a screen and of a chemical treatment as described above.

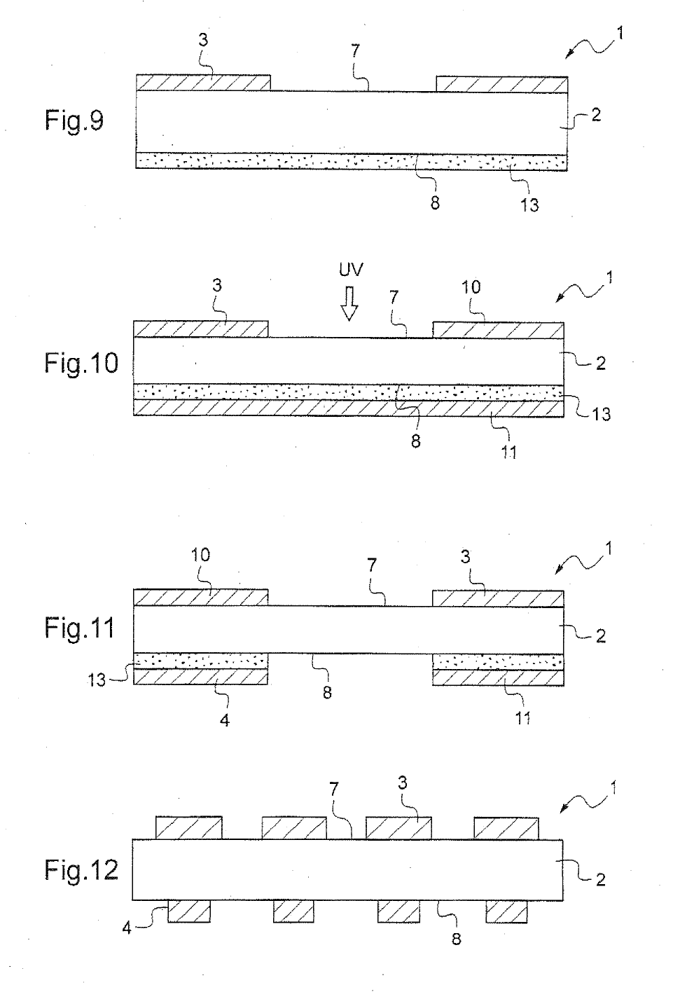

In the step represented in FIG. 9, a layer of a resin 13, capable of being modified chemically under the action of ultraviolet radiation (UV), is disposed on the verso 8 of the substrate 2.

In the step represented in FIG. 10, a second metallic layer 11 is applied to the verso 8 of the security element 1 on the resin layer 13.

Next, ultraviolet radiation (UV) is directed from the side of the recto 7 of the security element 1, at the level of the zones of the substrate 2 not comprising first metallized marks 3. In this way, the parts of the resin layer 13 that are subjected to the UV radiation disappear, and thereby the metallic parts of the metallic layer 11 which are disposed on the parts of the resin layer 13 removed.

FIG. 11 represents the final result obtained after exposure to UV radiation. The security element 1 comprises first metallized marks 3 on the recto 7 of the substrate 2, and second metallized marks 4 on the verso 8 of the substrate 2, the marks 3 and 4 being totally superimposed on one another. The second metallized marks 4 are not in direct contact with the substrate 2 but are disposed on the parts of the resin layer 13 which have not been subjected to UV radiation.

The method can furthermore comprise a step consisting in forming the first 5 and/or the second 6 patterns, formed respectively by the first marks 3 and second marks 4, in particular by application of a screen and chemical treatment as described above.

Another exemplary security element 1 according to the invention has been represented, in section, in FIG. 12.

In this example, the first marks 3 are substantially superimposed on the second marks 4. The first marks 3 have in particular identical widths, which could as a variant be different, greater than the widths of the second marks 4 also all identical, but which could also as a variant be different.

Another exemplary security element 1 according to the invention has been represented, in section, in FIG. 13. In this example, the second marks 4 are formed by two sets 4a and 4b consisting of different prints and/or metallizations. The sets 4a and 4b are juxtaposed with one another but could as a variant be spaced mutually apart.

The set 4a is for example of red color and the set 4b is for example of blue color. When the recto of the security element 1 is observed at a positive or negative angle (right or left) with respect to the normal to the recto of the security element 1, it is possible to see the second marks 4 with a different color, red or blue. In particular, when observing from the left side of a plane of separation coinciding with the mid-plane of the recto of the security element 1, it is possible to observe the set 4a of blue color, and when observing from the right side of the mid-plane of the recto of the security element 1, it is possible to observe the set 4b of red color.

The substrate 2 and/or the first marks 3 can as a variant also exhibit specific aspects, particularly colors, which can be combined with the sets 4a and 4b so as to form particular coloration effects.

Photographs of a security element 1 in accordance with the invention have been represented, in a face-on view, in FIGS. 14 and 15.

FIG. 14 represents the observation of the security element 1 from the vertical (at normal incidence). It is seen that only the first marks 3 are observed.

FIG. 15 represents the observation of the security element 1 at an angle of 45°. It is seen that the image formed by the superposition of the first marks 3 and second marks 4 is then observed.

FIG. 16 represents another example, in section, of security element 1 in accordance with the invention.

The security element 1 comprises for example a substrate 2 on the recto 7 of which are contained first marks 3 of identical widths.

On the verso 8 of the substrate 2 are contained second marks 4 of different widths. The widths of the second marks 4 may be chosen in such a way that a first part of the second marks 4 is visible only at a first angle of observation with respect to the recto 7 of the substrate 2 and that a second part of the second marks 4 is visible only by observation of the recto 7 of the substrate 2 at a second angle different from the first angle. In particular, the observation of the recto 7 of the substrate 2 at an angle equal to 90° with respect to the recto 7, represented by the arrows F₁ in FIG. 16, can make it possible to observe only the first marks 3, the second marks 4 being hidden by the first marks 3.

Observation of the recto 7 at a first angle α, represented by the arrows F₂ in FIG. 16, can make it possible to observe only a first part of the second marks 4. In particular, observation at the first angle α can make it possible to observe a part of the second mark 4′ and the whole of the first marks 3, as may be seen in FIG. 16. On the other hand, observation of the second marks 4″ is not possible at the first angle α. Observation of the recto 7 of the substrate 2 at a second angle β, different from the first angle α, represented in FIG. 16 by the arrows F₃, can make it possible to observe a second part of the second marks 4. In particular, observation at the second angle β can make it possible to observe the second marks 4″ and the first marks 3, as may be seen in FIG. 16, but also to observe the totality of the second mark 4″.

In this way, it is thus possible to control the visibility, total or partial, of the second marks 4 as a function of the widths of the second marks 4. In particular, when the second marks 4 have widths equal to the widths of the first marks 3, it is possible to observe the totality of the second marks 4 by observation at a given angle. On the other hand, when the second marks 4 have variable widths, less than the widths of the first marks 3, it is possible to observe a first part of the second marks 4 by observation at a first angle, and then a second part of a second mark 4 by observation at a second angle different from the first angle. In this way, the invention can for example make it possible to observe an image that alters as a function of the value of the angle of observation.

Of course, the invention is not limited to the exemplary embodiments which have just been described. The security element could comprise a multilayer substrate comprising one or more layers furnished with marks such as defined above. In this way, the combination of the first marks and second marks with the marks of the substrate could achieve other visual effects during observation.

The expression “comprising a” is synonymous with “comprising at least one”.

1. A security element comprising an at least partially transparent substrate, comprising first marks and second marks in the form of metallizations and/or of prints disposed respectively on a verso and recto of the substrate, wherein the first marks are substantially superimposed on the second marks, wherein the first marks and second marks respectively form first and second distinct patterns according to their respective disposition on the verso or rector of the substrate, the degree of visibility of the second marks varying with the angle of observation of the recto of the security element, and the thickness of the substrate ranging from 5 μm to 100 μm.

2. The security element as claimed in claim 1, wherein the widths of the first marks are greater than or equal to the widths of the second marks.

3. The security element as claimed in claim 1, wherein the first marks and second marks are metallizations.

4. The security element as claimed in claim 1, wherein the first marks and second marks are prints.

5. The security element as claimed in claim 1, wherein the second marks are visible only by observation of the recto of the security element at an angle different from 90°.

6. The security element as claimed in claim 1, wherein the first marks are superimposed exactly on the second marks.

7. The security element as claimed in claim 1, wherein the first marks and second marks are situated on either side of a transparent zone of the substrate.

8. The security element as claimed in claim 1, wherein the substrate is visible between the first marks and the second marks.

9. The security element as claimed in claim 1, wherein the first marks and/or the second marks comprise a pattern in the form of a rastered image.

10. The security element as claimed in claim 9, wherein the rastered image comprises a set of mutually parallel lines.

11. The security element as claimed in claim 1, wherein the first and second patterns are formed by parallel lines with the same line count.

12. The security element as claimed in claim 1, wherein the security element comprises a security thread.

13. The security element as claimed in claim 1, wherein the thickness of the substrate ranges from 10 μm to 50 μm.

14. The security element as claimed in claim 1, wherein the width of the security element ranges from 1 mm to 30 mm.

15. The security element as claimed in claim 1, wherein the substrate comprises (2) comprising a polymer chosen from among polyethylene (PE), polyvinyl chloride (PVC), polyethylene terephthalate (PET), polycarbonate (PC), polyester carbonate (PEC), polyethylene terephthalate glycol (PETG), and acrylonitrile butadiene styrene (ABS).

16. The security element as claimed in claim 1, wherein at least one non-opaque colored layer being is applied to at least one of the recto and the verso of the substrate.

17. The security element as claimed in claim 1, wherein the second marks are formed by two sets of marks comprising prints of different colors and/or of different metallizations.

18. A security document comprising a security element as claimed in claim 1.

19. The security document as claimed in claim 19, wherein the security element comprises a security thread introduced in bulk or as one or more windows into the security document, or applied at the surface on the security document.

20. A method of authentication of a security element as claimed in claim 1 or of a security document as claimed in claim 18, comprising:
observing the recto and/or the verso of the security element at a nonzero angle of observation with respect to the normal to the recto and/or to the verso of the security element; and
determining whether the security element or the security document is authentic based on the occurrence of the appearance of the image formed by the second pattern.

21. The method of authentication as claimed in claim 20, wherein the observing occurs at an angle of observation ranging from 20° and to 70°.

22. A method of manufacture of a security element as claimed in claim 1, comprising:
forming first marks and second marks in the form of metallizations and/or of prints partially on a recto and/or a verso of an at least partially transparent substrate, such that the first marks are substantially superimposed on the second marks and such that the first marks and second marks form respectively first and second distinct patterns according to their respective disposition on the recto or verso of the substrate.

23. The method of manufacture as claimed in claim 22,
wherein forming the first marks comprises performing a first demetallization of a metallic layer present on the recto of the substrate, the first demetallization forming a replica of the first marks on the verso of the substrate; and
performing another demetallization of the first marks and/or second marks to form the first and second distinct patterns.

24. The security element as claimed in claim 13, wherein the thickness of the substrate ranges from 15 μm to 30 μm.

25. The security element as claimed in claim 14, wherein the width of the security element ranges from 4 mm to 15 mm.
